(19) United States
(12) Patent Application Publication
(10) Pub. No.: US 2018/0219219 A1
(43) Pub. Date: Aug. 2, 2018

(54) LITHIUM ION SECONDARY BATTERY, METHOD OF PREPARING ELECTRODE ACTIVE MATERIAL COMPOSITE, AND METHOD OF PREPARING LITHIUM ION SECONDARY BATTERY

(71) Applicant: Samsung Electronics Co., Ltd., Suwon-si (KR)

(72) Inventors: Seitaro ITO, Kanagawa (JP); Yuichi AIHARA, Kanagawa (JP)

(21) Appl. No.: 15/848,074

(22) Filed: Dec. 20, 2017

(30) Foreign Application Priority Data
Dec. 27, 2016 (JP) 2016-253413
Jun. 30, 2017 (KR) 10-2017-0083605

(51) Int. Cl. H01M 4/36; H01M 10/0525; H01M 10/0562; H01M 4/505; H01M 4/525; H01M 4/62

(52) U.S. Cl. CPC H01M 4/366; H01M 10/0525; H01M 10/0562; H01M 2004/028; H01M 4/525; H01M 4/628; H01M 2300/0068; H01M 4/505

(57) ABSTRACT

A lithium ion secondary battery includes: a positive electrode; a negative electrode wherein least one of the positive electrode and the negative electrode includes an electrode active material composite including an electrode active material particle, and a needle-shaped crystal of a first sulfide solid electrolyte in contact with the electrode active material particle, wherein the needle-shaped crystal has an aspect ratio of greater than 2; and a second sulfide solid electrolyte between the positive electrode and the negative electrode and in contact with the electrode active material composite.

### CROSS-REFERENCE TO RELATED APPLICATIONS

This application claims the benefit of and priority to Japanese Patent Application No. 2016-253413, filed on Dec. 27, 2016, in the Japanese Patent Office, and Korean Patent Application No. 10-2017-0083605, filed on Jun. 30, 2017, in the Korean Intellectual Property Office, and all the benefits accruing therefrom under 35 U.S.C. § 119, the contents of which are incorporated herein in their entireties by reference.

### BACKGROUND

### 1. Field

The present disclosure relates to a lithium ion secondary battery, a method of manufacturing an electrode active material composite, and a method of manufacturing a lithium ion secondary battery

### 2. Description of the Related Art

Recently, all-solid-state lithium ion secondary batteries including a lithium ion conductive solid electrolyte have drawn attention. All-solid-state lithium ion secondary batteries are expected to have improved energy density and stability, as compared with lithium ion secondary batteries including a conventional electrolytic solution.

In order for such all-solid-state lithium ion secondary batteries to have excellent load characteristics, the batteries should have excellent lithium ion conductivity at an interface between an electrode active material and an electrolyte. Thus, in order to improve lithium ion conductivity, Japanese Patent No. 4982866 discloses a technique of coating a surface of a positive active material with LiTi₂(PO₄)₃, which is a known non-sulfide-based solid electrolyte. Also, Japanese Patent Laid-Open Publication No. 2015-201372 discloses contacting a solid electrolyte solution with a positive active material to prepare an active material composite coated with a solid electrolyte.

### SUMMARY

Provided are an improved lithium ion secondary battery having enhanced load characteristics, a method of preparing an electrode active material composite, and a method of manufacturing a lithium ion secondary battery.

Additional aspects will be set forth in part in the description which follows and, in part, will be apparent from the description, or may be learned by practice of the presented embodiments.

According to an aspect of an embodiment, a lithium ion secondary battery includes: a positive electrode and a negative electrode, wherein at least one of the positive electrode and the negative electrode includes an electrode active material composite including an electrode active material particle, and a needle-shaped crystal of a first sulfide solid electrolyte in contact with the electrode active material particle, wherein the needle-shaped crystal has an aspect ratio of greater than 2; and a second sulfide solid electrolyte between the positive electrode and the negative electrode and in contact with the electrode active material composite.

According to an aspect of an embodiment, a method of preparing an electrode active material composite includes: mixing a solution including a solid electrolyte dissolved in a first solvent with a second solvent to form a mixture; heating the mixture at a pressure greater than 1 megapascal to obtain a mixed liquid, wherein a solubility of the sulfide solid electrolyte in the second solvent is less than a solubility of the sulfide solid electrolyte in the first solvent; cooling the mixed liquid to precipitate a needle-shaped crystal of the sulfide solid electrolyte in the mixed liquid, wherein the needle-shaped crystal has an aspect ratio of greater than 2; and attaching the needle-shaped crystal to a surface of an electrode active material particle to prepare the electrode active material composite.

According to an aspect of an embodiment, a method of manufacturing a lithium ion secondary battery includes: providing a positive electrode and a negative electrode, wherein at least one of the positive and the negative electrode includes the electrode active material composite; and disposing a second sulfide solid electrolyte between the positive electrode and the negative electrode to manufacture a lithium ion secondary battery.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic cross-sectional view of an embodiment of a layered structure of a lithium ion secondary battery;

FIG. 2 is a schematic view of an embodiment of a method of preparing a positive active material composite;

FIG. 3 is a scanning electron microscope (“SEM”) image of a Li₃PS₄ crystal prepared in Example 1;

FIG. 4 is an SEM image of a positive active material composite prepared in Example 1;

FIG. 5 is an image obtained using energy dispersive X-ray spectroscopy (“EDX”) of the positive active material composite prepared in Example 1;

FIG. 6 is an SEM image of a positive active material composite prepared in Comparative Example 2 (at a magnification of 1,000 times);

FIG. 7 is an SEM image of the positive active material composite prepared in Comparative Example 2 (at a magnification of 10,000 times);

FIG. 8A is a schematic view of a positive active material composite of Examples 1 to 7;

FIG. 8B is a schematic view of a positive active material composite of Comparative Examples 1 and 3; and

FIG. 8C is a schematic view of the positive active material composite of Comparative Example 2.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. Expressions such as “at least one of,” when preceding a list of elements, modify the entire list of elements and do not modify the individual elements of the list.

Hereinafter with reference to attached drawings, example embodiments of the present disclosure will be described in detail. Throughout the specification and the drawings, like reference numerals refer to like elements.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

A C rate means a current which will discharge a battery in one hour, e.g., a C rate for a battery having a discharge capacity of 1.6 ampere-hours would be 1.6 amperes.

### 1. Summary of Lithium Ion Secondary Battery

With respect to techniques to improve lithium ion conductivity, it has not been possible to achieve sufficient load characteristics. Thus, the present disclosure has been designed to resolve the problem.

A lithium ion secondary battery according to an embodiment is an all-solid-state lithium ion secondary battery including a solid electrolyte as an electrolyte.

Because an electrode active material and an electrolyte are solid in an all-solid-state lithium ion secondary battery including a solid electrolyte, it may be difficult for the electrolyte to permeate into the electrode active material, as compared with a lithium ion secondary battery including an organic solvent as an electrolyte. Accordingly, in an all-solid-state lithium ion secondary battery, an interfacial area between an electrode active material and a solid electrolyte may be small. Thus, it is desirable that a sufficient migration pathway is provided for lithium ions and electrons between the electrode active material and the solid electrolyte.

Therefore, for example, it is known that a positive electrode layer may be formed as a mixed layer of a positive active material and a solid electrolyte to increase an interfacial area between a positive active material and a solid electrolyte, and techniques of coating a surface of a positive active material with a solid electrolyte. Here, in the case that a surface of a positive active material is coated with a solid electrolyte, lithium ion conductivity may greatly improve.

However, the present inventors took note that a solid electrolyte coated on a positive active material prevents electrons from migrating. A solid electrolyte may be deposited on a surface of a positive active material by a liquid phase method, and thus the surface of the positive active material may be coated continuously and uniformly. In this case, the positive active material may not secure an electron migration pathway sufficiently.

The present inventors reviewed the aforementioned problem, and found that when an electrode active material particle is covered with a solid electrolyte having a specific form such that a surface of the electrode active material particle is coated with a solid electrolyte non-continuously, the surface of the electrode active material particle may be exposed, resulting in a sufficient increase in lithium ion conductivity and electron conductivity.

Thus, a lithium ion secondary battery according to the present disclosure may include an electrode active material composite including an electrode active material particle and a needle-shaped crystal, e.g., having an aspect ratio of greater than 2, of a first sulfide solid electrolyte coated on the electrode active material particle; and a second sulfide solid electrolyte in contact with the electrode active material composite.

In addition, the electrode active material particle may be either a positive active material particle or a negative active material particle. In an embodiment, the electrode active material particle is a positive active material particle.

In an embodiment, a lithium ion secondary battery may include a positive electrode and a negative electrode. Both of the positive and negative electrode may include an electrode active material composite including an electrode active material particle and a needle-shaped crystal of a first sulfide solid electrolyte coated on the electrode active material particle. When both the positive and negative electrode include the needle-shaped crystal of a first sulfide solid electrolyte, the electrode active material particles of the positive and negative electrode differ, i.e., the positive electrode includes positive active material particles and the negative electrode includes negative active material particles.

Thus, a lithium ion secondary battery 1 according to an embodiment may include a positive active material composite 100 including a positive active material particle and a needle-shaped crystal of a first sulfide solid electrolyte coated on the positive active material particle; and a second sulfide solid electrolyte 300 in contact with the positive active material composite 100. Therefore, both lithium ion conductivity and electron conductivity may sufficiently increase in the positive active material composite 100 of the lithium ion secondary battery 1 according to an embodiment, which may lead to an improvement of load characteristics.

### 2. Structure of Lithium Ion Secondary Battery

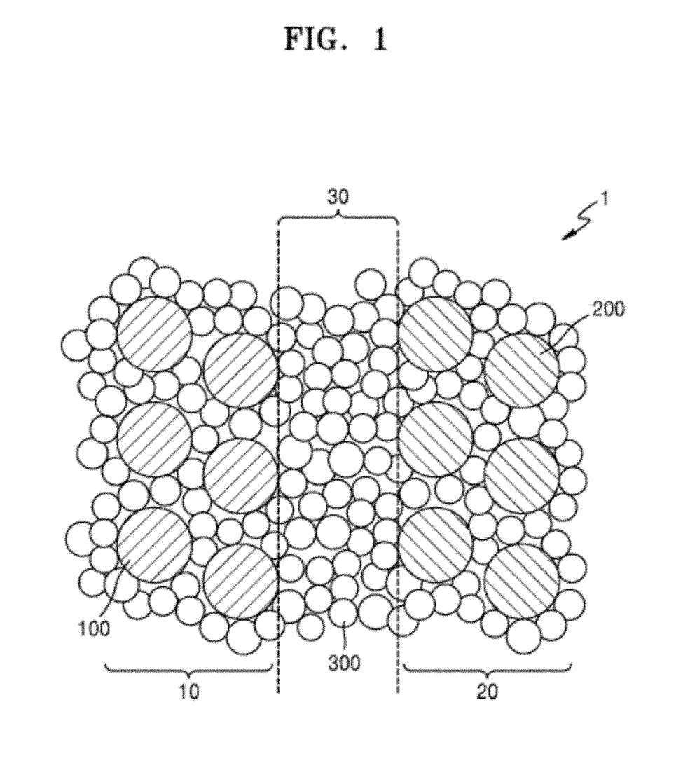

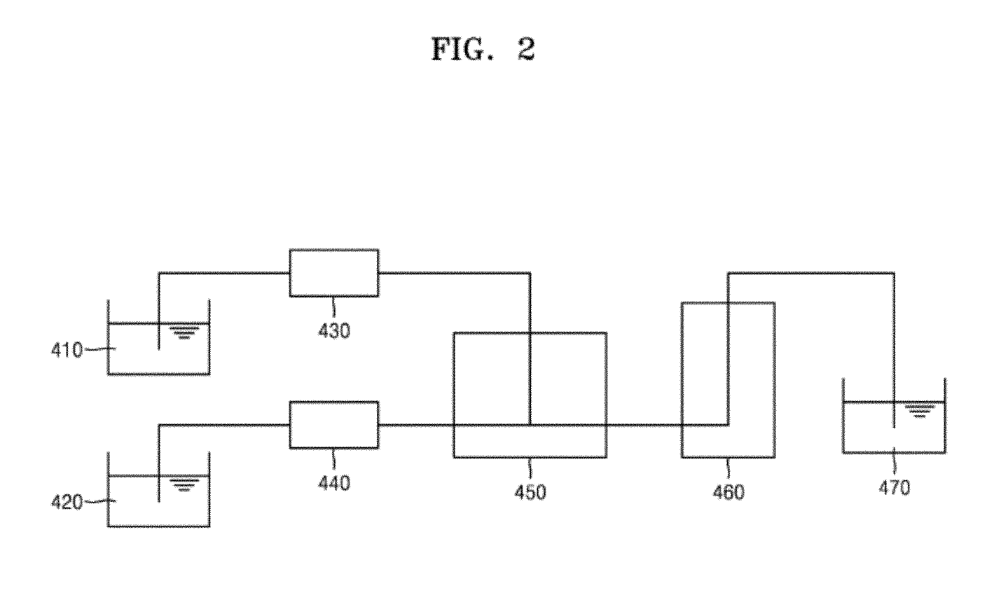

Referring to FIGS. 1 and 2, the structure of the aforementioned lithium ion secondary battery according to an embodiment will be described in further detail. FIG. 1 is a schematic cross-sectional view of an embodiment of a layered structure of the lithium ion secondary battery 1.

As shown in FIG. 1, the lithium ion secondary battery 1 may have a stacked structure including a positive electrode layer 10, a negative electrode layer 20, and a solid electrolyte layer 30 between the positive electrode layer 10 and the negative electrode layer 20.

### Positive Electrode Layer

The positive electrode layer 10 may include a positive active material composite 100 and the solid electrolyte (the second sulfide solid electrolyte) 300. The positive electrode layer 10 may further include a conductive agent to increase electron conductivity. The solid electrolyte 300 will be disclosed below in relation to the solid electrolyte layer 30.

The positive active material composite 100 may include a surface coated with a lithium-containing compound layer and a needle-shaped crystal layer of a first sulfide solid electrolyte, which are coated in this stated order.

### Positive Active Material Composite

The positive active material composite 100 may have a greater charge-discharge potential, as compared with a negative active material composite included in the negative electrode layer 20, and provide for reversible intercalation and deintercalation of lithium ions.

For example, the positive active material composite 100 may include, as a positive active material particle, a lithium compound such as lithium cobalt oxide (hereinafter, referred to as “LCO”), lithium nickel oxide, lithium nickel cobalt oxide, lithium nickel cobalt aluminum oxide (hereinafter, referred to as “NCA”), lithium nickel cobalt manganese oxide (hereinafter, referred to as “NCM”), lithium manganese oxide, or lithium iron phosphate; nickel sulfide; copper sulfide; sulfur; iron oxide; or vanadium oxide. Such a positive active material particle may include of the above-mentioned materials alone or in a combination.

In addition, among the aforementioned lithium compounds, the positive active material composite 100 may include a lithium transition metal oxide having a layered rock-salt type structure. As used herein, the term “layered” refers to a thin sheet form. The expression “rock-salt type structure” refers to a sodium chloride-type structure as a crystal structure in which face-centered cubic lattices of anions and cations are each shifted by half a side of each unit lattice. Examples of the lithium transition metal oxide having a layered rock-salt type structure may be a ternary lithium transition metal oxide represented by the formula LiNₓCo_{y}Al_{z}O₂ (“NCA”) or LiNiₓCo_{y}Mn_{z}O₂ (“NCM”), wherein 0<x<1, 0<y<1, 0<z<1, and x+y+z=1.

When the lithium salt of a ternary transition metal oxide having a layered rock-salt type structure is included in the positive active material composite 100, the lithium ion secondary battery 1 may have improved energy density and improved thermal stability.

In addition, when the positive active material composite 100 includes a lithium ternary transition metal oxide such as NCA or NCM, and nickel (Ni) as a positive active material, capacity density of the lithium ion secondary battery 1 may increase, which may lead to less metal dissolution of a positive active material when charging the battery. Therefore, with respect to charging, the long-term reliability and cycle characteristics of the lithium ion secondary battery 1 according to an embodiment may improve.

The positive active material composite 100 may have any suitable shape, e.g., a spherical shape or an oval shape. In addition, the positive active material composite 100 may have an average particle diameter in a range of, for example, about 0.1 micrometer (μm) to about 50 μm. Here, the “average particle diameter” refers to a number average particle diameter in a distribution of particle diameters obtained by a light scattering method, and may be measured by a particle diameter distribution meter or the like.

In the positive electrode layer 10, an amount of the positive active material composite 100 may be, for example, in a range of about 10% by weight to about 99% by weight, or for example, in the a range of about 20% by weight to about 90% by weight.

### Lithium-Containing Compound Layer

A lithium-containing compound layer may be formed on a surface of the positive active material composite 100, wherein the lithium-containing compound layer may be formed by a lithium ion conductive lithium-containing compound. Accordingly, a reaction between the positive active material composite 100 and the solid electrolyte 300 may be prevented while maintaining lithium ion conductivity. The lithium-containing compound layer is not particularly limited. Examples thereof include an alloy including lithium as a lithium-containing compound and a metal element other than lithium. The metal element other than lithium is not particularly limited. Examples thereof include aluminum (Al), zirconium (Zr), titanium (Ti), niobium (Nb), germanium (Ge), indium (In), yttrium (Y), gallium (Ga), boron (B), and bismuth (Bi). A combination comprising at least one of the foregoing may be used.

The lithium-containing compound may be a lithium-containing oxide or a lithium-containing phosphorus oxide. Examples of the lithium-containing oxide include lithium zirconium oxide (Li—Zr—O), lithium niobium oxide (Li—Nb—O), lithium titanium oxide (Li—Ti—O), lithium aluminum oxide (Li—Al—O), and lithium germanium oxide (Li—Ge—O). In addition, examples of the lithium-containing phosphorus oxide include lithium titanium phosphorus oxide (Li—Ti—PO₄) and lithium zirconium phosphorus oxide (Li—Zr—PO₄). Examples of the lithium-containing compound include Li₂ZrO₃, LiNbO₃, Li₂TiO₃, LiAlO₄, LiGeO, LiTi₂(PO₄)₃, and LiZr(PO₄)₃.

By using such a lithium-containing compound layer, formation of a highly resistant layer at an interface between the positive active material composite 100 and the solid electrolyte 300 may be suppressed. Thus, the lithium ion conductivity between the positive active material composite 100 and the solid electrolyte 300 may improve significantly.

In an embodiment, the lithium-containing compound may be aLi₂O—ZrO₂ (wherein 0.1≤a≤2.0). aLi₂O—ZrO₂ (hereinafter, referred to as “LZO”) is chemically stable. Thus, when a lithium-containing compound layer includes aLi₂O—ZrO₂, a reaction between the positive active material composite 100 and the solid electrolyte 300 may be greatly suppressed. aLi₂O—ZrO₂ may be a composite oxide of Li₂O and ZrO₂, wherein 0.1≤a≤2.0. When “a” is within this range, the lithium ion secondary battery 1 may have greatly improved battery characteristics.

The positive active material composite 100 may be coated with the lithium-containing compound layer, in which the coating amount of the lithium-containing compound may be in a range of, for example, about 0.1 mole percent (mol %) to about 2 mol %, based on the total moles of the positive active material particle. When the coating amount of the lithium-containing compound layer is within this range, the discharge capacity and load characteristics of the battery may greatly improve.

In addition, a thickness of the lithium-containing compound layer is not particularly limited. For example, the thickness thereof may be in a range of about 0.5 nanometer (nm) to about 30 nm, and in some embodiments, about 1 nm to about 15 nm. When the thickness of the lithium-containing compound layer is within any of these ranges, lithium ion conductivity may not be reduced, while increasing suppression of a reaction between the positive active material composite 100 and the solid electrolyte 300.

In addition, at least a portion of the positive active material composite 100 may be coated with the lithium-containing compound layer. That is, an entire surface of the positive active material composite 100 may be coated with the lithium-containing compound layer, or a portion of a surface of the positive active material composite 100 may be coated with the lithium-containing compound layer. If needed, the lithium-containing compound layer may be omitted.

### First Sulfide Solid Electrolyte

A needle-shaped crystal of a first sulfide solid electrolyte may be coated on a surface of the positive active material composite 100 by being coated on a lithium-containing compound layer. As such, the needle-shaped crystal of the first sulfide solid electrolyte may be coated on a surface of the positive active material particle in the positive active material composite 100. Thus, the surface may be non-continuously coated with the first sulfide solid electrolyte. That is, a portion of a surface of the positive active material composite 100 may be covered with the first sulfide solid electrolyte and another portion thereof may not be covered with the first sulfide solid electrolyte. The portion of the positive active material composite 100 covered with the first sulfide solid electrolyte may have increased lithium ion conductivity. The portion of the positive active material composite 100 not covered with the first sulfide solid electrolyte may provide sufficient electron conductivity. Therefore, the positive active material composite 100 may have both improved lithium ion conductivity and improved electron conductivity.

A length of a major axis of a needle-shaped crystal of the first sulfide solid electrolyte is not particularly limited. For example, the major axis length may be in a range of about 0.5 μm to 1,000 μm, in some embodiments, about 1 μm to about 800 μm, and in some embodiments, about 2 μm to about 500 μm. An average length of a major axis of a needle-shaped crystal of the first sulfide solid electrolyte is not particularly limited. For example, the average major axis length may be in a range of about 0.5 μm to 1,000 μm, in some embodiments, about 1 μm to about 800 μm, and in some embodiments, about 2 μm to about 500 μm. Thus, the portion covered with the first sulfide solid electrolyte and the portion not covered with the first sulfide solid electrolyte may be disposed appropriately on a surface of the positive active material composite 100. Accordingly, the positive active material composite 100 may have improved lithium ion conductivity and excellent electron conductivity.

A length of a minor axis of a needle-shaped crystal of the first sulfide solid electrolyte is not particularly limited. For example, the average minor axis length may be in a range of about 5 nm to 500 nm, in some embodiments, about 10 nm to about 400 nm, and in some embodiments, about 20 nm to about 200 nm. An average length of a minor axis of a needle-shaped crystal of the first sulfide solid electrolyte is not particularly limited. For example, the average minor axis length may be in a range of about 5 nm to 500 nm, in some embodiments, about 10 nm to about 400 nm, and in some embodiments, about 20 nm to about 200 nm. Thus, the portion covered with the first sulfide solid electrolyte and the portion not covered with the first sulfide solid electrolyte may be disposed appropriately on a surface of the positive active material composite 100. Accordingly, the positive active material composite 100 may have excellent lithium ion conductivity and excellent electron conductivity.

An aspect ratio of a needle-shaped crystal of the first sulfide solid electrolyte is not particularly limited. For example, the aspect ratio may be in a range of about 2 to 1,000, in some embodiments, about 3 to about 800, and in some embodiments, about 3 to about 500. Also, an average aspect ratio of the needle-shaped crystal of the first sulfide solid electrolyte is not particularly limited. For example, the average aspect ratio may be in a range of about 2 to 1,000, in some embodiments, about 3 to about 800, and in some embodiments, about 3 to about 500. Thus, the portion covered with the first sulfide solid electrolyte and the portion not covered with the first sulfide solid electrolyte may be disposed appropriately on a surface of the positive active material composite 100. Accordingly, the positive active material composite 100 may have excellent lithium ion conductivity and excellent electron conductivity.

The major axis and the minor axis of a needle-shaped crystal may be measured by observing the positive active material composite 100 of the lithium ion secondary battery 1, for example, with a scanning electron microscope (SEM). In a case where a needle-shaped crystal is prepared by the method disclosed below, an agglomerate of the needle-shaped crystal may be present in the positive electrode layer 10. In this case, it may be relatively easy to measure a major axis and a minor axis of a needle-shaped crystal in the agglomerate of the needle-shaped crystal, and the major axis and the minor axis of the agglomerate of the needle-shaped crystal may be regarded as a major axis and a minor axis of a needle-shaped crystal of the first sulfide solid electrolyte in the positive active material composite 100. Before attaching a needle-shaped crystal to the positive active material particle in a suspension obtained upon preparation of the needle-shaped crystal, a major axis and a minor axis of the needle-shaped crystal may be measured. The measured values may also be regarded as a major axis and a minor axis of a needle-shaped crystal of the first sulfide solid electrolyte in the positive active material composite 100.

The first sulfide solid electrolyte may include a solid sulfide electrolyte material. Examples of the solid sulfide electrolyte material may include Li₃PS₄, Li₂S—P₂S₅, Li₂S—P₂S₅—LiX (X may be a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n may each be a positive number, and Z may be Ge, Zn, or Ga), Li₂S—GeS₂, Li₂S—SiS₂—Li₃PO₄, and Li₂S—SiS₂—Li_{P}MO_{q} (wherein p and q may each be a positive number, and M may be P, Si, Ge, B, Al, Ga, or In). At least one of the foregoing materials may be used as the solid sulfide electrolyte material.

In an embodiment, the first sulfide solid electrolyte may include solid sulfide electrolyte materials including at least sulfur (S), phosphorus (P), and lithium (Li). In some embodiments, the first sulfide solid electrolyte may include at least Li₂S—P₂S₅.

When a material including Li₂S—P₂S₅ is used as a solid sulfide electrolyte material constituting the first sulfide solid electrolyte, a molar ratio of Li₂S to P₂S₅ (Li₂S:P₂S₅) in a mixture may be, for example, about 50:50 to about 90:10.

The positive active material composite 100 may be coated with a needle-shaped crystal of the first sulfide solid electrolyte in a range of, in an embodiment, about 0.1 percent by weight (wt %) to about 15 wt %, in an embodiment, about 0.5 wt % to about 10 wt %, and in an embodiment, about 1 wt % to about 8.5 wt %, based on the total weight of the positive active material particle. Thus, the portion covered with the first sulfide solid electrolyte and the portion not covered with the first sulfide solid electrolyte may be disposed appropriately on a surface of the positive active material composite 100. Accordingly, the positive active material composite 100 may have excellent lithium ion conductivity and excellent electron conductivity.

The positive electrode layer 10 may further include an additive, such as a conductive agent, a binder, a filler, a dispersing agent, and an ion-conductive agent, in addition to the positive active material composite 100 and the solid electrolyte 300.

Examples of the conductive agent that may be further included in the positive electrode layer 10 include graphite, carbon black, acetylene black, Ketjen black, carbon fiber, and metal powder. Examples of the binder that may be further included in the positive electrode layer 10 include polytetrafluoroethylene, polyvinylidene fluoride, and polyethylene. Moreover, a filler, a dispersing agent, or an ion conductive agent that may be included in the positive electrode layer 10 may be any suitable material for an electrode in lithium ion secondary batteries.

### Negative Electrode Layer

The negative electrode layer 20 may include, for example, a negative active material composite 200 and the solid electrolyte 300. The solid electrolyte 300 will be disclosed below in relation to the solid electrolyte layer 30.

The negative active material composite 200 may include a negative active material having a lower charge-discharge potential than that of the positive active material in the positive active material composite 100, wherein the negative active material is alloyable with lithium and provides for reversible intercalation and deintercalation of lithium ions.

In an embodiment, the negative active material may be a metal active material or a carbon active material. The metal active material, may be, for example, a metal such as lithium (Li), indium (In), aluminum (Al), tin (Sn), silicon (Si), or an alloy thereof. Examples of the carbon active material include, for example, artificial graphite, graphite carbon fiber, resin-sintered carbon, carbon grown by vapor-phase thermal decomposition, coke, mesophase carbon microbeads (“MCMBs”), furfuryl alcohol resin-sintered carbon, a polyacene, pitch carbon fibers (“PCF”), vapor grown carbon fiber, natural graphite, and non-graphitizable carbon. Such a negative active material may include one of the above-mentioned materials or a combination of at least two thereof.

In addition, as described above, a surface of the negative active material composite 200 may be coated with a needle-shaped crystal of a sulfide solid electrolyte. In this case, the sulfide solid electrolyte may be the same as or different from the aforementioned first sulfide solid electrolyte and the solid electrolyte 300 disclosed below. The coating conditions therefore may be the same as those for the positive active material particle.

The negative electrode layer 20 may further include an additive, such as a conductive agent, a binder, a filler, a dispersing agent, or an ion-conductive agent, in addition to the negative active material composite 200 and the solid electrolyte 300.

Additives that may be included in the negative electrode layer 20 may be the same as those of the positive electrode layer 10.

In addition, the negative electrode layer 20 is not limited to the aforementioned examples. In some embodiments, the negative electrode layer 20 may be a metal lithium layer.

### Solid Electrolyte Layer

The solid electrolyte layer 30 may include the solid electrolyte (the second sulfide solid electrolyte) 300 between the positive electrode layer 10 and the negative electrode layer 20.

The solid electrolyte 300 may include a sulfide solid electrolyte material. The sulfide solid electrolyte material is not particularly limited, and may be the same as the first sulfide solid electrolyte. The solid electrolyte 300 may include the same material as or a material different from the first sulfide solid electrolyte. In addition, the solid electrolyte 300 included in the positive electrode layer 10, the solid electrolyte layer 30, and the negative electrode layer 20 may be the same or different among each of the layers.

The solid electrolyte 300 may have any suitable shape, e.g., a spherical shape or an oval shape. The particle diameter of the solid electrolyte 300 is not particularly limited. In an embodiment, the average particle diameter of the solid electrolyte 300 may be in a range of about 0.01 μm to about 30 μm, and in an embodiment, about 0.1 μm to about 20 μm. As described above, the “average particle diameter” refers to a number average particle diameter in a distribution of particle diameters obtained by a light scattering method.

Hereinbefore, the structure of the lithium ion secondary battery 1 according to an example embodiment has been described in detail. In addition, in the lithium ion secondary battery 1, a current collector (not shown) may be disposed so as to be in contact with the positive electrode layer 10 and the negative electrode layer 20.

### 3. Preparation of Positive Active Material Composite

A method of preparing an electrode active material composite according to an example embodiment will be described. FIG. 2 is a schematic view of an embodiment of a method of preparing an electrode active material composite. Here, for illustrative purposes, the electrode active material composite is described as a positive active material composite. However, embodiments are not limited thereto, and the electrode active material composite may be a negative active material composite.

A method of preparing an electrode active material composite according to an embodiment may include obtaining a solution by dissolving a first sulfide solid electrolyte in a first solvent, and then mixing the solution with a second solvent in which the first sulfide solid electrolyte is less soluble than in the first solvent, under a heated and pressurized environment, to obtain a mixed liquid (mixing process); cooling the mixed liquid to precipitate a needle-shaped crystal of the first sulfide solid electrolyte in the mixed liquid (precipitation process); and attaching the needle-shaped crystal to a surface of the electrode active material particle (coating process). Hereinafter, the method will be described in detail.

First, before the mixing process, a solution 420 is prepared in which the solid-phase first sulfide electrolyte is dissolved in the first solvent.

The first solvent for dissolving the first sulfide solid electrolyte is not particularly limited. The first solvent may be any suitable solvent in which the first sulfide electrolyte is highly soluble, i.e., a strong solvent. A strong solvent for the first sulfide electrolyte may be a solvent having weak polarity. In some embodiments, the first solvent may include an alcohol solvent other than methanol, an amide solvent, an ether solvent, or a combination thereof.

Examples of the alcohol solvent include a C₂ to C₈ alcohol having a straight or branched chain, or a C₂ to C₄ alcohol having a straight or branched chain. More particularly, the alcohol solvent may be a straight-chain alcohol, e.g., ethanol, n-propyl alcohol, n-butyl alcohol, n-pentyl alcohol, n-hexyl alcohol, n-heptyl alcohol, or n-octyl alcohol; or a branched alcohol, e.g., isopropyl alcohol, isobutyl alcohol, sec-butyl alcohol, or tert-butyl alcohol.

Examples of the amide solvent include dimethyl formamide, diethyl formamide, dimethyl acetamide, N-methyl formamide, N-methylpyrrolidone, and 1,1,3-trimethylurea.

Examples of the ether solvent include tetrahydrofuran, dimethyl ether, ethylmethyl ether, and diethyl ether.

A solubility of the first sulfide electrolyte in the first solvent may be 1 milligram per milliliter (mg/mL) or greater at a temperature of about 20° C.

The first sulfide electrolyte may be dissolved in the first solvent, for example, at a temperature in a range of about 0° C. to about 200° C., and in some embodiments, about 20° C. to about 100° C.

In an embodiment, a concentration of the first sulfide electrolyte in the resulting solution may be, for example, about 1 gram per liter (g/L) or greater and about 1,000 g/L or less, and in an embodiment, about 3 g/L or greater and about 500 g/L or less.

Next, in the mixing process, the solution 420 and a second solvent 410 may be mixed to prepare a mixed liquid under a heated and pressurized environment. The solubility of the second solvent 410 with respect to first sulfide electrolyte may be relatively low. However, when the solution 420 is mixed with the second solvent 410 under a heated and pressurized environment, precipitation of the first sulfide electrolyte from the mixed liquid may be prevented.

In particular, as shown in FIG. 2, the second solvent 410 may be supplied to a heating apparatus 450 through a pump 430, and the solution 420 be supplied to the heating apparatus 450 through a pump 440. Thus, the second solvent 410 and the solution 420 may be heated and mixed in the heating apparatus 450. In addition, in this case, the second solvent 410 and the solution 420 may each be in a pressurized state in the heating apparatus 450 due to the pumps 430 and 440.

In the mixing process, the solution 420 and the second solvent 410 may be mixed at a temperature in a range of, for example, about 50° C. to about 300° C., and in some embodiments, about 100° C. to about 250° C. As such, the precipitation of the first sulfide electrolyte in the mixed liquid may be reliably prevented.

In an embodiment, in the mixing process, the pressure may be, for example, about 1 megapascal (MPa) or greater and about 50 MPa or less, and in some embodiments, about 10 MPa or greater and about 40 MPa or less. Accordingly, vaporization, such as by evaporation or boiling of the solution 420, the second solvent 410, and the mixed liquid, may be prevented, thereby maintaining the mixed liquid in a liquid state. As a result, unintended precipitation of the first sulfide solid electrolyte may be prevented.

In an embodiment, the mixing process may be performed under a condition when the first solvent in the solution 420 and the second solvent 410 are each a supercritical fluid. Therefore, in the mixing process, unintended precipitation of the first sulfide electrolyte may be prevented, and thus the first sulfide electrolyte may be reliably dissolved in the mixed liquid.

The second solvent 410 is not particularly limited; as long as solubility of the first sulfide electrolyte in the second solvent 410 is lower than that in the first solvent at a temperature of about 20° C. The second solvent may be a weak solvent in which the first sulfide electrolyte has low solubility. The weak solvent with respect to the first sulfide electrolyte may be a nonpolar solvent having little polarity. The second solvent 410 may include a hydrocarbon solvent, a nonpolar aromatic solvent, or a combination thereof.

Examples of the hydrocarbon solvent include straight or branched chain saturated hydrocarbons containing 5 to 10 carbon atoms, such as pentane, hexane, heptane, and octane, and cyclic hydrocarbons containing 5 to 10 carbon atoms, such as cyclohexane, cyclopentane, cycloheptane, and cyclooctane.

Examples of the nonpolar aromatic solvent include aromatic hydrocarbons containing 6 to 10 carbon atoms, such as benzene, toluene, and xylene.

In some embodiments, a solubility of the first sulfide electrolyte in the second solvent 410 may be 10 mg/mL or less at a temperature of about 20° C.

In the mixing process, although not particularly limited thereto, the second solvent 410 may be mixed with the solution 420 in a volume ratio in a range of about 1:1 to about 1:30, and in some embodiments, about 1:2 to about 1:20.

Next, in the precipitation process, the mixed liquid may be cooled to precipitate a needle-shaped crystal of the first sulfide electrolyte in the mixed liquid. The mixed liquid may be quenched via a cooling system 460. Here, the mixed liquid is mixed with the second solvent 410, and thus, a solubility of the first sulfide electrolyte in the mixed liquid may be lower than in the solution 420. Thus, a needle-shaped crystal of the first sulfide electrolyte may be rapidly precipitated by the quenching, thereby obtaining a mixed liquid 470 after the precipitation.

In the precipitation process, a cooling rate of the mixed liquid may be, for example, about 10° C./second (sec) or greater, in some embodiments, about 50° C./sec or greater and about 500° C./sec or less, and in some embodiments, about 100° C./sec or greater and about 300° C./sec or less. When the cooling rate is within any of these ranges, the size and shape of the needle-shaped crystal may be relatively uniform.

A cooling termination temperature in the precipitation process may be, for example, in a temperature range of about 0° C. to about 100° C., and in some embodiments, about 10° C. to about 50° C.

Next, in the coating process, the mixed liquid 470 which results may be mixed with a positive active material particle to facilitate adhesion of the needle-shaped crystal onto a surface of the positive active material particle. In an example embodiment, a positive active material particle may be added to the mixed liquid 470 and the mixed liquid 470 may be mixed with the positive active material particle. However, embodiments of the present disclosure are not limited thereto. For example, first, the solution 420 containing the first sulfide electrolyte dissolved in the first solvent may be mixed with the positive active material particle. Then, the solution 420 may undergo the mixing process and the precipitation process, which may result in quenching under a heated and pressurized environment to adhere a needle-shaped crystal onto a surface of the positive active material particle.

The added amount of the positive active material particle is not particularly limited, and may be changed according to a need, for example, a desired coating amount of needle-shaped crystals. In some embodiments, the positive active material particle may be prepared according to a separate known method before performing the coating process.

In some embodiments, a surface of the positive active material composite 100 as described above may be further coated with a lithium-containing compound layer. Hereinafter, a method of preparing the positive active material composite 100 further coated with the lithium-containing compound layer will be described in detail.

For example, when NCA is used as the positive active material particle, first, Ni(OH)₂ powder, Co(OH)₂ powder, Al₂O₃.H₃O powder, and LiOH.H₂O powder may be mixed in the same composition ratio as in the NCA to be formed, and the mixture may be ground using a ball mill. Continuously, the ground powder of mixed raw materials may be mixed with a dispersing agent, a binder, and the like. A viscosity of the mixture may be adjusted and the mixture may be molded in the form of a sheet. Then, the molded product in sheet form may be sintered at a selected temperature, and the sintered product may be pulverized by using a sieve (mesh) to obtain the positive active material particle. In this regard, a size of the positive active material particle may be adjusted by changing a hole size of the sieve (mesh) used to pulverize the molded product.

Then, a lithium-containing compound layer may be formed on the resulting positive active material particle. The lithium-containing compound layer may be, for example, prepared as follows.

In some embodiments, first, lithium alkoxide and an alkoxide of a heterogeneous element included in a lithium-containing compound may be stirred and mixed with a solvent to adjust the mixed solution. The solvent may include an organic solvent, such as alcohol or ethyl acetoacetate, and water. Although a time for the stirring and mixing is not particularly limited, the time for the stirring and mixing may be, for example, about 30 minutes.

Ethyl acetoacetate has a structure of CH₃—CO—CH₂—CO—O—R (wherein R may be, for example, an alkyl group). In this structure, chelating effects caused by two carbonyl groups may stabilize an unstable metal. That is, ethyl acetoacetate or the like may serve as a stabilizer for the alkoxide of the heterogeneous element included in the lithium-containing compound. In the case that the heterogeneous element is stable, addition of ethyl acetoacetate is not necessary.

Subsequently, a positive active material particle may be added to the adjusted mixed solution, and then the mixture may be stirred. Then, the mixed solution may be heated and subjected to reduced pressure while being irradiated with ultrasound. After the solvent is evaporated, the positive active material particle may be sintered at a selected temperature for a selected duration, thereby forming a lithium-containing compound layer including the lithium-containing compound.

In some embodiments, after the solvent is evaporated, the positive active material particle may be sintered at a temperature of about 750° C. or less for about 0.5 hours to about 3 hours.

By the disclosed method, the positive active material composite 100, on which a needle-shaped crystal of the first sulfide solid electrolyte is coated, may be prepared.

### 4. Method of Manufacturing Lithium Ion Secondary Battery

Hereinafter, a method of manufacturing the lithium ion secondary battery 1 according to an example embodiment will be described in detail. A method of manufacturing the lithium ion secondary battery 1 according to the present disclosure may include a method of preparing the electrode active material composite according to the present disclosure. Thus, a method of manufacturing the lithium ion secondary battery 1 according to an example embodiment may include the method of preparing the positive active material composite 100 described above according to an example embodiment. The lithium ion secondary battery 1 according to an example embodiment may be manufactured by first preparing the positive electrode layer 10, the negative electrode layer 20, and the solid electrolyte layer 30, and then stacking each of the layers.

### Preparation of Positive Electrode Layer

First, the prepared positive active material composite 100, the solid electrolyte 300 prepared by a method to be described below, and various additives may be mixed together, and a solvent, e.g., water or an organic solvent, may be added thereto to prepare a slurry or a paste. The resulting slurry or paste may be coated on a current collector, dried, and roll-pressed, thereby preparing the positive electrode layer 10. However, embodiments are not limited thereto. The positive active material composite 100, the solid electrolyte 300, and various additives may be dried, mixed, and then pressurized to form the positive electrode layer 10 in pellet form.

### Preparation of Negative Electrode Layer

When the negative electrode layer 20 is prepared by mixing the solid electrolyte 300 with the negative active material composite 200, the negative active material composite 200, the solid electrolyte 300 prepared by the method described below, and various additives may be mixed together, and then a solvent e.g., water or an organic solvent, may be added thereto to prepare a slurry or a paste. The resulting slurry or paste may be coated on a current collector, dried, and roll-pressed, thereby preparing the negative electrode layer 20. The negative active material composite 200 may be prepared using the negative active material according to any suitable known method. In some embodiments, the negative active material composite 200 may be coated with a needle-shaped crystal of a sulfide solid electrolyte according to the method of preparing the positive active material composite 100. In some embodiments, the negative electrode layer 20 may be a lithium metal foil.

Examples of the current collector for preparing the positive electrode layer 10 and the negative electrode layer 20 include a plate or a foil including indium (In), copper (Cu), magnesium (Mg), stainless steel, titanium (Ti), iron (Fe) cobalt (Co), nickel (Ni), zinc (Zn), aluminum (Al), germanium (Ge), lithium (Li), an alloy thereof, or a combination thereof. In some embodiments, the positive electrode layer 10 or the negative electrode layer 20 may be prepared by consolidating a mixture of the positive active material composite 100 or the negative active material composite 200 and various additives into pellets, without using a current collector.

### Preparation of Solid Electrolyte Layer

The solid electrolyte layer 30 may be prepared using the solid electrolyte 300 including a sulfide solid electrolyte material.

First, a sulfide solid electrolyte material may be prepared by using a melt quenching method or a mechanical milling (“MM”) method. For example, when using the melt quenching method, first, Li₂S and P₂S₅ may be mixed in a selected ratio and the mixture may be compressed into pellets. The pellets may be reacted at a reaction temperature in a vacuum and quenched to prepare a sulfide solid electrolyte material. In this regard, the reaction temperature of the mixture of Li₂S and P₂S₅ may be in a range of about 400° C. to about 1,000° C., and in some embodiments, about 800° C. to about 900° C. A reaction time may be in a range of about 0.1 hours to about 12 hours, for example, in a range of about 1 hour to about 12 hours. Furthermore, a temperature during the quenching of the reactants may be equal to or less than about 10° C., for example, equal to or less than about 0° C., and a quenching rate may be in a range of about 1° C./sec to about 10,000° C./sec, for example, about 1° C./sec to about 1,000° C./sec.

According to the MM method, Li₂S and P₂S₅ may be mixed in a selected ratio and reacted while stirring using e.g., a ball mill, to thereby prepare a sulfide solid electrolyte material. Although the stirring rate and duration of the MM method are not particularly limited, as the stirring rate increases, a rate of production of the sulfide solid electrolyte material may increase, and as the stirring duration increases, a conversion rate of raw materials into the sulfide solid electrolyte material may increase.

Then, the sulfide solid electrolyte material prepared by the melt quenching method or the MM method may be thermally treated at a selected temperature and ground to prepare the solid electrolyte 300 in particle form.

The solid electrolyte 300 thus obtained may be used to form the solid electrolyte layer 30 by any suitable known method for layer formation, such as blasting, aerosol deposition, cold spraying, sputtering, chemical vapor deposition (CVD), or spraying. Further, the solid electrolyte layer 30 may be prepared by pressurizing the solid electrolyte 300. The solid electrolyte layer 30 may be prepared by mixing the solid electrolyte 300, a solvent, and a binder or a support, to prepare a mixture, and then pressurizing the mixture. In this regard, a binder or a support may be added to reinforce the strength of the solid electrolyte layer 30 or to prevent a short circuit of the solid electrolyte 300.

### Manufacture of Lithium Ion Secondary Battery

The positive electrode layer 10, the negative electrode layer 20, and the solid electrolyte layer 30 that are prepared as described above may be stacked such that the solid electrolyte layer 30 may be disposed between the positive electrode layer 10 and the negative electrode layer 20. The stacked structure may be pressurized to manufacture the lithium ion secondary battery 1 according to an example embodiment.

### EXAMPLES

Hereinafter the lithium ion secondary battery 1 according to an example embodiment will be described with reference to Examples and Comparative Examples. However, these Examples are for illustrative purposes only, and thus the lithium ion secondary battery according to an example embodiment is not limited to the following Examples.

### Example 1

### (1) Preparation of Positive Active Material Composite

First, 0.5% lithium methoxide and zirconium propoxide were mixed with isopropanol to obtain 320 g of a mixed solution. 1,000 g of a positive active material particle was coated with Li₂ZrO₃ (LZO) in the mixed solution by using an electromotive flux coating device, such that a content of LZO precursor was 0.5 mol % based on the total weight of the positive active material particle. Afterwards, the mixture was stirred and mixed for 15 minutes. As a positive active material particle, an active material particle having an empirical formula of LiNi_{0.8}Co_{0.1}Mn_{0.1}O₂ was used.

The resulting positive active material particle was sintered in an air atmosphere at a temperature of 350° C. for 1 hour, thereby forming a lithium-containing compound layer including LZO on a surface of the positive active material particle.

Subsequently, 500 mg of Li₃PS₄ was dissolved in 100 mL of a first solvent, thereby obtaining a solution. The solution was heated at a pressure of 30 MPa and at a temperature of 200° C. Then, this solution was mixed with cyclohexane (a second solvent), which also had been heated and pressurized, in a volume ratio of 1:10. Next, the mixture was allowed to pass through a water bath to quench at a rate of 150° C./s until a temperature of 20° C. was reached, so as to precipitate a needle-shaped Li₃PS₄ crystal.

Then, 5 g of the LiNi_{0.8}Co_{0.1}Mn_{0.1}O₂ coated with LZO was added to a solution, from which the needle-shaped Li₃PS₄ crystal was precipitated, thereby coating a surface of the LiNi_{0.8}Co_{0.1}Mn_{0.1}O₂ with the Li₃PS₄ crystal. The coating amount of the Li₃PS₄ crystal was 6.5 wt % based on the total weight of the positive active material particle. By following the method described above, the positive active material composite 100 was prepared.

### (2) Manufacture of Lithium Ion Cell

100 mg of Li₃PS₄, as a solid electrolyte 300, was stacked in a cell container having an inner diameter of 13 mm, and then trimmed by using a molding device to prepare the solid electrolyte layer 30. The prepared positive active material composite 100, the solid electrolyte 300, and carbon nanofibers (conductor) were mixed in a weight ratio of 60:35:5. 15 mg of the mixture thus obtained was stacked on the solid electrolyte layer 30. The surface of the mixture was trimmed by using a molding device, thereby forming the positive electrode layer 10.

Next, a lithium metal foil, i.e., the negative electrode layer 20, having a thickness of 30 μm, was attached to the side opposite the positive electrode layer 10. Then, a pressure of 3 tons per square centimeter (t/cm²) was applied to the stacked structure of the negative electrode layer 20, the solid electrolyte layer 30, and the positive electrode layer 10 in the cell container to prepare pellets, thereby obtaining a test cell of Example 1.

### Example 2

A test cell of Example 2 was manufactured in substantially the same manner as in Example 1, except that the positive active material composite 100 was prepared such that the coating amount of the Li₃PS₄ crystal was 3.2 wt %, based on the total weight of the positive active material particle.

### Example 3

A test cell of Example 3 was manufactured in substantially the same manner as in Example 1, except that the positive active material composite 100 was prepared such that the coating amount of the Li₃PS₄ crystal was 1.3 wt %, based on the total weight of the positive active material particle.

### Comparative Example 1

A test cell of Comparative Example 1 was manufactured in substantially the same manner as in Example 1, except that a surface of the positive active material particle was not coated with the Li₃PS₄ crystal.

### Comparative Example 2

A test cell of Comparative Example 2 was manufactured in substantially the same manner as in Example 1, except that a surface of a positive active material particle was coated with the Li₃PS₄ crystal in an amount of 6.5 wt %, and treated as follows.

As in Example 1, the positive active material particle coated with LZO was added to an isopropanol solution including Li₃PS₄, and then dried by evaporating a solvent therefrom using a rotary evaporator. The dried product was vacuum-dried at a temperature of 70° C., thereby obtaining the positive active material particle.

### Electrochemical Evaluation

Electrochemical evaluation was performed on the test cells manufactured in Examples 1 to 3 and Comparative Examples 1 and 2 in an argon atmosphere at a temperature of 25° C. The evaluation was performed as follows. First, regarding theoretical capacity, each test cell was charged with a constant current of 0.05 C until the voltage reached a voltage of 4.0V (upper limit voltage). Then, each test cell was discharged with a constant current of 0.05 C, 0.33 C, and 1 C until the voltage reached a voltage of 3.0V (lower limit voltage). Thus, the average discharge voltage thereof was evaluated. The results thereof are shown in Table 1.

TABLE 1

| | | | | | Comparative | Comparative |
|---|---|---|---|---|---|---|
| | | Example 1 | Example 2 | Example 3 | Example 1 | Example 2 |
| Li₃PS₄ crystal | Crystal shape | Needle | Needle | Needle | — | — |
| | | shape | shape | shape | | |
| | Coating amount | 6.5 | 3.2 | 1.3 | — | 6.5 |
| | (wt %) | | | | | |
| Average | 0.05 C | 3.70 | 3.69 | 3.69 | 3.70 | 3.68 |
| discharge | | | | | | |
| voltage (V) | | | | | | |
| | 0.33 C | 3.69 | 3.67 | 3.67 | 3.66 | 3.61 |
| | 1.0 C | 3.66 | 3.58 | 3.62 | 3.57 | 3.47 |

Referring to the results of Table 1, when a discharge current was 0.05 C, the average discharge voltage of the test cells of Examples 1 to 3 was not different from those of Comparative Examples 1 and 2; however, when a discharge current was 1.0 C, the average discharge voltage increased, indicating improved load characteristics.

In addition, regarding the Li₃PS₄ crystal obtained in Example 1, in the prepared recovery solution of the Li₃PS₄ crystal, the Li₃PS₄ crystal was observed by using a scanning electron microscope (“SEM”). The major axis, minor axis, and aspect ratio of a hundred needle-shaped crystals were measured to obtain an average major axis, an average minor axis, and an average aspect ratio. The resulting average major axis was 2 μm, the resulting average minor axis was 100 nm, and the average aspect ratio was 20. In addition, because the same recovery solution of the Li₃PS₄ crystal was used in Examples 2 and 3 and Examples 4 to 7, the major axis, the minor axis, and the aspect ratio of the needle-shaped crystals in Examples 2 and 3 and Examples 4 to 7 may be the same as those of Example 1.

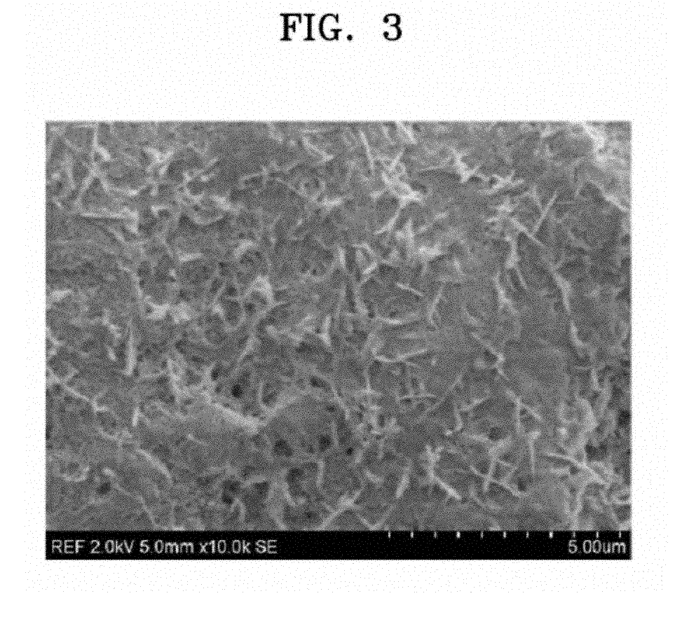

The SEM image of the Li₃PS₄ crystal prepared in Example 1 is shown in FIG. 3. As shown in FIG. 3, the Li₃PS₄ crystal has a needle-shaped form.

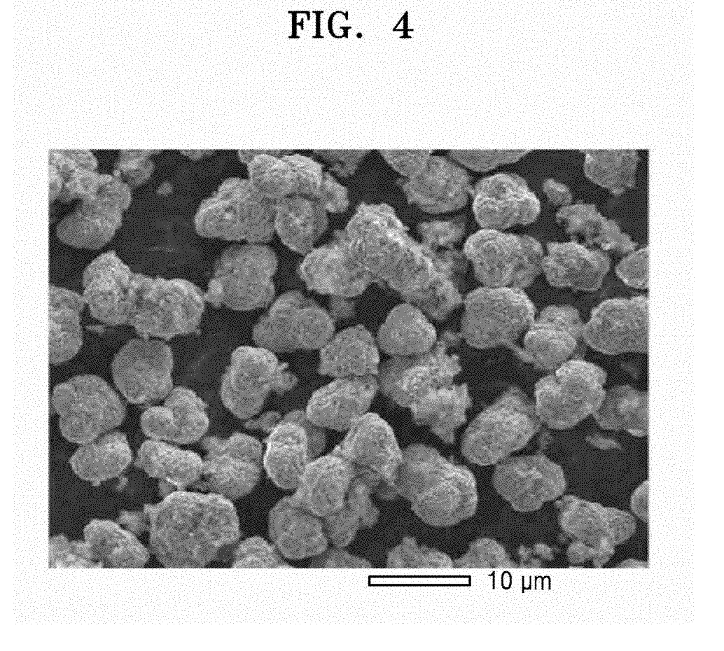

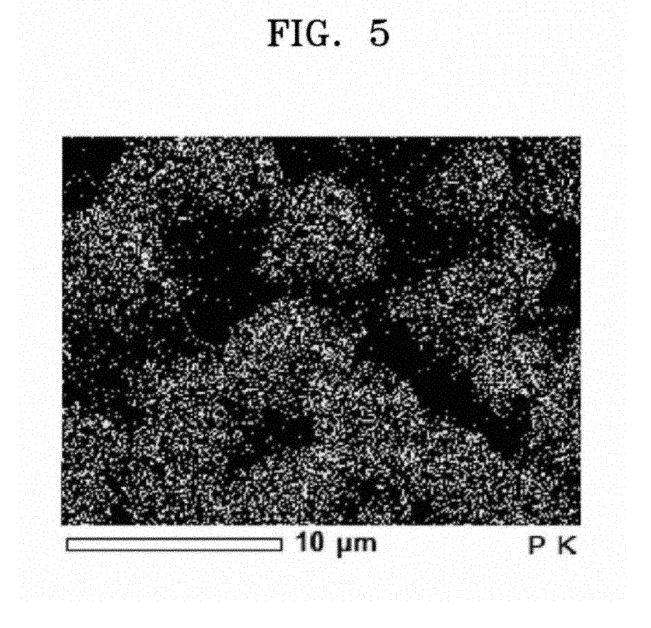

FIG. 4 is an SEM image of the positive active material composite of Example 1. FIG. 5 is an image obtained using energy dispersive X-ray spectroscopy (“EDX”) of the positive active material composite of Example 1. As shown in FIG. 4, the positive active material composite is seen to have fine bumps, and is coated with Li₃PS₄ crystals. As shown in FIG. 5, P and S can be observed on the surface of the positive active material composite uniformly. Accordingly, it was found that the needle-shaped Li₃PS₄ crystals cover the positive active material particle relatively uniformly. However, the needle-shaped Li₃PS₄ crystals did not form a continuous film; rather, the needle-shaped Li₃PS₄ crystals covered the positive active material particle non-continuously.

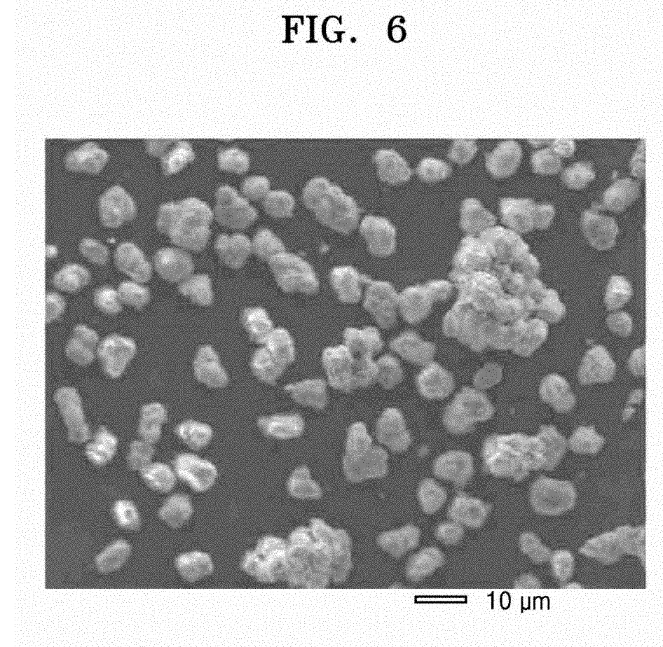

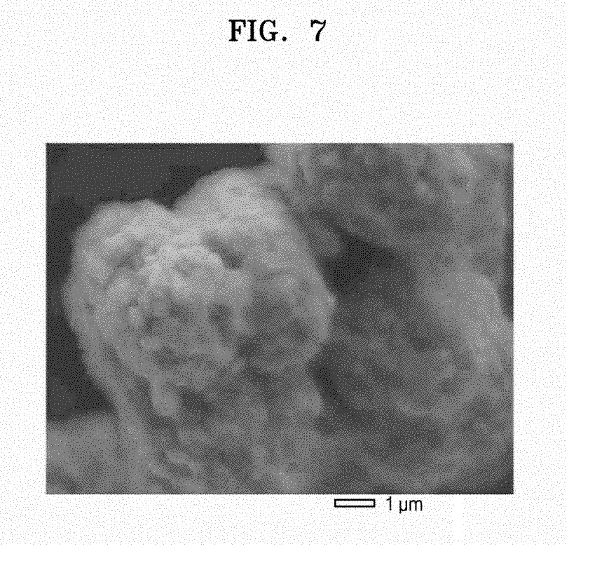

FIGS. 6 and 7 are each an SEM image of the positive active material composite of Comparative Example 2. As shown in FIGS. 6 and 7, the positive active material composite of Comparative Example 2 was found to have a uniform and continuous Li₃PS₄ film covering a surface of the positive active material particle.

### Example 4

A test cell of Example 4 was manufactured in substantially the same manner as in Example 1, except that the positive active material composite 100 was prepared such that the coating amount of the Li₃PS₄ crystal was 8.1 wt %, based on the total weight of the positive active material particle, the positive electrode layer 10 had a weight ratio of 80:13.3:6.7 (the positive active material composite 100:the solid electrolyte 300:carbon nanofibers (conductor)), and the stacked amount of the positive electrode layer 10 was 11.3 mg.

### Example 5

A test cell of Example 5 was manufactured in substantially the same manner as in Example 4, except that the positive active material composite 100 was prepared such that the coating amount of the Li₃PS₄ crystal was 6.5 wt %, based on the total weight of the positive active material particle.

### Example 6

A test cell of Example 6 was manufactured in substantially the same manner as in Example 4, except that the positive active material composite 100 was prepared such that the coating amount of the Li₃PS₄ crystal was 3.2 wt %, based on the total weight of the positive active material particle.

### Example 7

A test cell of Example 7 was manufactured in substantially the same manner as in Example 4, except that the positive active material composite 100 was prepared such that the coating amount of the Li₃PS₄ crystal was 1.3 wt %, based on the total weight of the positive active material particle.

### Comparative Example 3

A test cell of Comparative Example 3 was manufactured in substantially the same manner as in Comparative Example 1, except that the positive electrode layer 10 had a weight ratio of 80:13.3:6.7 (the positive active material composite 100:the solid electrolyte 300:carbon nanofibers (conductor)), and the stacked amount of the positive electrode layer 10 was 11.3 mg.

### Electrochemical Evaluation

Electrochemical evaluation was performed on the test cells manufactured in Examples 4 to 7 and Comparative Example 3 in an argon atmosphere at a temperature of 25° C. The evaluation was performed as follows. First, regarding theoretical capacity, each test cell was charged with a constant current of 0.05 C until the voltage reached a voltage of 4.0V (upper limit voltage). Then, each test cell was discharged with a constant current of 0.05 C until the voltage reached a voltage of 3.0V (lower limit voltage). Thus, the discharge capacity thereof was evaluated. The results thereof are shown in Table 2.

TABLE 2

| | | | | | | Comparative |
|---|---|---|---|---|---|---|
| | | Example 4 | Example 5 | Example 6 | Example 7 | Example 3 |
| Li₃PS₄ crystal | Crystal shape | Needle | Needle | Needle | Needle | — |
| | | shape | shape | shape | shape | |
| | Coating amount | 8.5 | 6.5 | 3.2 | 1.3 | 6.5 |
| | (wt %) | | | | | |

| | | | | | |
|---|---|---|---|---|---|
| Discharge capacity (milliampere | 81.0 | 67.5 | 50.1 | 57.0 | 45.4 |
| hours per gram, (mAh/g) upon | | | | | |
| discharge with 0.05 C) | | | | | |

Referring to the results of Table 2, it was found that, when a discharge current was 0.05 C, the discharge capacity of each of the test cells of Examples 4 to 7 was greatly different from that of Comparative Example 3, indicating improved battery characteristics.

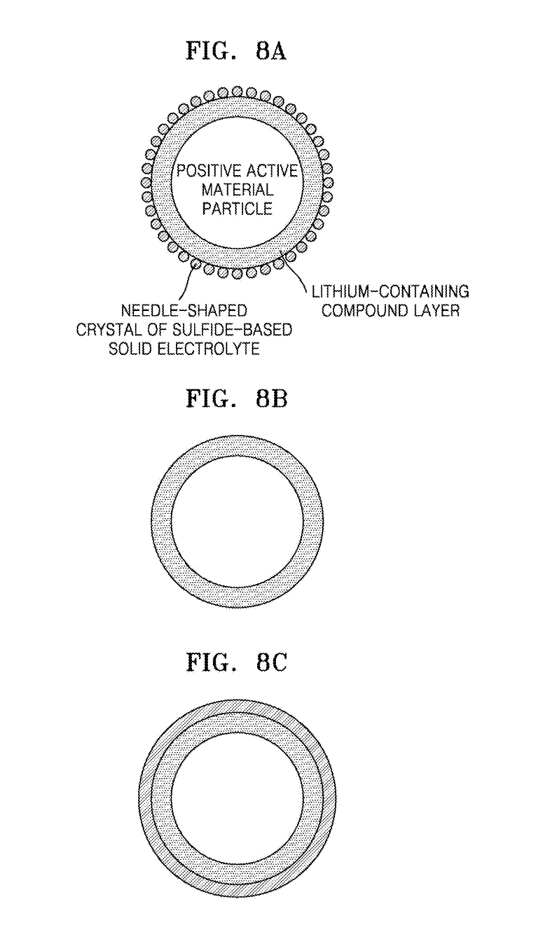

FIG. 8A is a schematic view of the positive active material composite of Examples 1 to 7. FIG. 8B is a schematic view of the positive active material composite of Comparative Examples 1 and 3. FIG. 8C is a schematic view of the positive active material composite of Comparative Example 2.

As shown in FIGS. 8A to 8C, a surface of each of the positive active material composites in the lithium ion secondary batteries (the test cells) of Examples 1 to 7 is covered with a needle-shaped crystal of a sulfide solid electrolyte. On the other hand, the positive active material composites of Comparative Example 1 and 3 are not covered with a solid electrolyte, and the positive active material composite of Comparative Example 2 is uniformly and continuously covered with a sulfide solid electrolyte.

As it can be seen from the above-described evaluation results, it was found that when a positive active material particle is covered with a needle-shaped crystal of a sulfide solid electrolyte, the lithium ion secondary battery 1 according to an example embodiment had improved load characteristics.

As described above, in a lithium ion secondary battery according to one or more embodiments, an electrode active material particle may be coated with a needle-shaped crystal of a sulfide solid electrolyte. Accordingly, lithium ion conductivity and electron conductivity at an interface between an electrode active material and a solid electrolyte may improve, which may lead to improvement of load characteristics of the lithium ion secondary battery.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A lithium ion secondary battery comprising:
a positive electrode;
a negative electrode,
wherein at least one of the positive electrode and the negative electrode comprises an electrode active material composite comprising
an electrode active material particle, and
a needle-shaped crystal of a first sulfide solid electrolyte in contact with the electrode active material particle, wherein the needle-shaped crystal has an aspect ratio of greater than 2; and
a second sulfide solid electrolyte between the positive electrode and the negative electrode and in contact with the electrode active material composite.

2. The lithium ion secondary battery of claim 1, wherein the first sulfide solid electrolyte and the second sulfide solid electrolyte each independently comprises Li₃PS₄, Li₂S—P₂S₅, Li₂S—P₂S₅—LiX, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ, Li₂S—GeS₂, Li₂S—SiS₂—Li₃PO₄, Li₂S—SiS₂—Li_{P}MO_{q}, or a combination thereof, wherein X is a halogen element, m and n are each a positive number, Z is Ge, Zn, or Ga, p and q are each a positive number, and M is P, Si, Ge, B, Al, Ga, or In.

3. The lithium ion secondary battery of claim 1, wherein an average aspect ratio of a plurality of the needle-shaped crystal is in a range of about 2 to about 1,000.

4. The lithium ion secondary battery of claim 1, wherein a length of a major axis of the needle-shaped crystal is in a range of about 0.5 micrometer to about 1,000 micrometers.

5. The lithium ion secondary battery of claim 1, wherein a length of a minor axis of the needle-shaped crystal is in a range of about 5 nanometers to about 500 nanometers.

6. The lithium ion secondary battery of claim 1, wherein an amount of the needle-shaped crystal is in a range of 0.1 percent by mass to about 15 percent by mass, based on a total mass of the electrode active material particle.

7. The lithium ion secondary battery of claim 1, wherein the needle-shaped crystal is non-continuously coated on the electrode active material particle.

8. The lithium ion secondary battery of claim 1, wherein the electrode active material particle is a positive active material particle.

9. The lithium ion secondary battery of claim 8, wherein the positive active material particle comprises lithium cobalt oxide, lithium nickel oxide, lithium nickel cobalt oxide, lithium nickel cobalt aluminum oxide, lithium nickel cobalt manganese oxide, lithium manganese oxide, lithium iron phosphate, or a combination thereof.

10. The lithium ion secondary battery of claim 1, wherein the electrode active material composite further comprises a lithium-containing compound layer between the electrode active material particle and the first sulfide solid electrolyte, wherein the lithium-containing compound layer comprises an alloy of lithium and a metal other than lithium.

11. The lithium ion secondary battery of claim 10, wherein the lithium-containing compound layer comprises lithium zirconium oxide, lithium niobium oxide, lithium titanium oxide, lithium aluminum oxide, lithium germanium oxide, lithium titanium phosphorus oxide, lithium zirconium phosphorus oxide, or a combination thereof.

12. The lithium ion secondary battery of claim 10, wherein the lithium-containing compound layer comprises aLi₂O—ZrO₂, wherein 0.1≤a≤2.0.

13. The lithium ion secondary battery of claim 10, wherein a thickness of the lithium-comprising compound layer is in a range of about 0.5 nanometers to about 30 nanometers.

14. A method of preparing an electrode active material composite, the method comprising:
mixing a solution comprising a solid electrolyte dissolved in a first solvent with a second solvent to form a mixture;
heating the mixture at a pressure greater than 1 megapascal to obtain a mixed liquid, wherein, a solubility of the sulfide solid electrolyte in the second solvent is less than a solubility of the sulfide solid electrolyte in the first solvent;
cooling the mixed liquid to precipitate a needle-shaped crystal of the sulfide solid electrolyte in the mixed liquid, wherein the needle-shaped crystal has an aspect ratio of greater than 2; and
attaching the needle-shaped crystal to a surface of an electrode active material particle to prepare the electrode active material composite.

15. The method of claim 14, wherein the first solvent comprises an alcohol wherein the alcohol is not methanol, an amide, an ether, or a combination thereof.

16. The method of claim 14, wherein the second solvent comprises a hydrocarbon solvent, a nonpolar aromatic solvent, or a combination thereof.

17. The method of claim 14, wherein the mixing of the solution with the second solvent is performed at a temperature in a range of about 50° C. to about 300° C.

18. The method of claim 14, wherein the mixing of the solution with the second solvent is performed in an environment in which the first solvent and the second solvent each becomes a supercritical fluid.

19. The method of claim 14, wherein the electrode active material composite further comprises a lithium-containing compound layer between the electrode active material particle and the needle-shaped crystal of the sulfide solid electrolyte.

20. A method of manufacturing a lithium ion secondary battery, the method comprising:
providing a positive electrode and a negative electrode, wherein at least one of the positive and the negative electrode comprises an electrode active material composite prepared by the method of claim 14; and
disposing a second sulfide solid electrolyte between the positive electrode and the negative electrode to manufacture a lithium ion secondary battery.
